(19) United States
(12) Patent Application Publication
(10) Pub. No.: US 2014/0310211 A1
(43) Pub. Date: Oct. 16, 2014

(54) Method and device for creating a nonparametric, data-based function model

(71) Applicants: Heiner Markert, Stuttgart (DE); Michael Hanselmann, Korntal (DE)

(72) Inventors: Heiner Markert, Stuttgart (DE); Michael Hanselmann, Korntal (DE)

(73) Assignee: Robert Bosch GmbH, Stuttgart (DE)

(21) Appl. No.: 14/247,520

(22) Filed: Apr. 8, 2014

(30) Foreign Application Priority Data
Apr. 10, 2013 (DE) 10 2013 206 291.5

(51) Int. Cl. G06N 99/00

(52) U.S. Cl. CPC G06N 99/005
USPC 706/12

(57) ABSTRACT

A method for creating a nonparametric, data-based function model having measuring points in multiple training data records, including the following: providing weighting specifications for the measuring points of each training data record; forming a set union of the measuring points of the multiple training data records; and creating the nonparametric function model from the set union of the measuring points of the training data records according to an algorithm which is dependent on the weighting specifications for the measuring points of the multiple training data records.

### RELATED APPLICATION INFORMATION

The present application claims priority to and the benefit of German patent application no. 10 2013 206 291.5, which was filed in Germany on Apr. 10, 2013, the disclosure of which is incorporated herein by reference.

### FIELD OF THE INVENTION

The present invention relates to methods for creating nonparametric, data-based function models, in particular based on Gaussian processes.

### BACKGROUND INFORMATION

Control unit functions which the control unit requires to carry out its intended control functions are usually implemented in control units of motor vehicles. The control unit functions are usually based on models which allow the system behavior to be emulated, in particular the behavior of an internal combustion engine to be controlled. Such function models are frequently described based on characteristic curves or characteristic maps, which are adapted to the control unit function to be modeled using complex application methods. Due to the high application complexity for adapting the function models, the entire development complexity is high. In addition, complex processes such as combustion processes in an internal combustion engine allow only an approximate creation of the physical function model, which in some circumstances is not sufficient for the control unit functions to be implemented.

It is provided in the publication DE 10 2010 028 266 A1, for example, to implement the function model in the form of a nonparametric, data-based model and to ascertain the calculation of the output variable using a Bayesian regression method. In particular, it is provided to implement the Bayesian regression as a Gaussian process or sparse Gaussian process.

### SUMMARY OF THE INVENTION

According to the present invention, a method for creating a nonparametric, data-based function model having measuring points of multiple training data records as recited in claim 1 and the device and the computer program as recited in the other independent claims are provided.

Further advantageous embodiments of the present invention are specified in the dependent claims.

According to a first aspect, a method for creating a nonparametric, data-based function model having measuring points in multiple training data records is provided. The method includes the following steps:
providing weighting specifications for the measuring points of each training data record;
forming a set union of the measuring points of the multiple training data records; and
creating the nonparametric function model from the set union of the measuring points of the training data records according to an algorithm which is dependent on the weighting specifications for the measuring points of the multiple training data records.

Nonparametric, data-based function models are usually created under a model assumption according to which the measuring uncertainty or the measuring noise is identical for all measuring points of the training data. This means that the concrete measuring error for each measuring point results from the normally distributed random variable having a standard deviation which applies equally to each measuring point. A function model created in this way results in a function whose function values at the measuring points may deviate from the output values of the training data at the measuring points.

However, in practice training data having multiple training data records may be present, which are to be weighted differently.

Selective data weighting of training data has so far not been provided for the creation of a conventional data-based function model from a training data volume. It is therefore provided to assign the training data records a weighting specification with which the corresponding measuring points are to be weighted.

In particular, the nonparametric, data-based function model may be defined with the aid of a covariance matrix, a diagonal matrix being applied to the covariance matrix, the diagonal matrix values which are assigned to the measuring points of the training data records being dependent on the assigned weighting specifications.

The weighting is thus carried out by manipulating a diagonal matrix which is applied to the covariance matrix to establish a variance which is valid for the measuring point in question.

Moreover, the multiple weighting specifications may be selected or determined by a user.

According to one specific embodiment, the measuring points of the training data records may in each case be assigned a level of a variance which is determined by the weighting

Moreover, the nonparametric, data-based function model may be ascertained as a Gaussian process model or as a sparse Gaussian process model.

According to one further aspect, a device, in particular an arithmetic unit, for adapting a nonparametric, data-based function model having measuring points in multiple training data records is provided, the device being configured to:
provide weighting specifications for the measuring points of each training data record;
form a set union of the measuring points of the multiple training data records; and
create the nonparametric, data-based function model from the set union of the measuring points of the training data records according to an algorithm which is dependent on the weighting specifications for the measuring points of the multiple training data records.

According to one further aspect, a computer program is provided which is configured to carry out all steps of the above-described method.

Specific embodiments of the present invention are described in greater detail hereafter based on the accompanying drawings.

### BRIEF DESCRIPTION OF THE DRAWINGS

FIG. 1 shows an exemplary illustration of two training data records, each having an identical number of measuring points.

FIG. 2 shows a flow chart to illustrate the method for creating a data-based function model based on first and second training data and the associated weightings.

FIGS. 3a and 3b show function curves of data-based function models which were obtained based on the first and second training data at different weightings.

### DETAILED DESCRIPTION

The use of nonparametric, data-based function models which are to map the control path and/or system models in control units is based on a Bayesian regression method. The fundamentals of the Bayesian regression are described in C. E. Rasmusen et al., “Gaussian Processes for Machine Learning,” MIT Press 2006, for example. The Bayesian regression is a data-based method using a model as the basis. Measuring points of training data as well as associated output data of an output variable are required to create the model. The model is created by using node data which entirely or partially correspond to the training data or which are generated from these. Moreover, abstract hyperparameters are determined, which parameterize the space of the model functions and effectively weight the influence of the individual measuring points of the training data on the later model prediction.

The abstract hyperparameters are determined by an optimization method. One option for such an optimization method is an optimization of a marginal likelihood p(Y|H,X). The marginal likelihood p(Y|H,X) describes the plausibility of the measured y values of the training data, represented as the vector Y, given the model parameters H and the x values of the training data. In the model training, p(Y|H,X) is maximized by finding suitable hyperparameters with which the data may be described particularly well. To simplify the calculation, the logarithm of p(Y|H,X) is maximized since the logarithm does not change the continuity of the plausibility function.

The optimization method automatically ensures a trade-off between model complexity and mapping accuracy of the model. While an arbitrarily high mapping accuracy of the training data is achievable with rising model complexity, this may result in overfitting of the model to the training data at the same time, and thus in a worse generalization property.

The result of the creation of the nonparametric function model that is obtained is:

$$v = {\sum }_{i = 1}^{N} ( {Q}_{y} ) {σ}_{f} exp ( - \frac{1}{2} {\sum }_{d = 1}^{D} \frac{{( {( {x}_{i} )}_{d} - {u}_{d} )}^{2}}{{I}_{d}} ) ,$$

where v corresponds to a standardized model value (output value) at a standardized test point u (input variable vector of the dimension D), xᵢ corresponds to a node of the node data, N corresponds to the number of nodes of the node data, D corresponds to the dimension of the input data/training data space/node data space, and I_{d}, σₙ and σ_{f} correspond to the hyperparameters from the model training. The vector Q_{y} is a variable calculated from the hyperparameters and the training data.

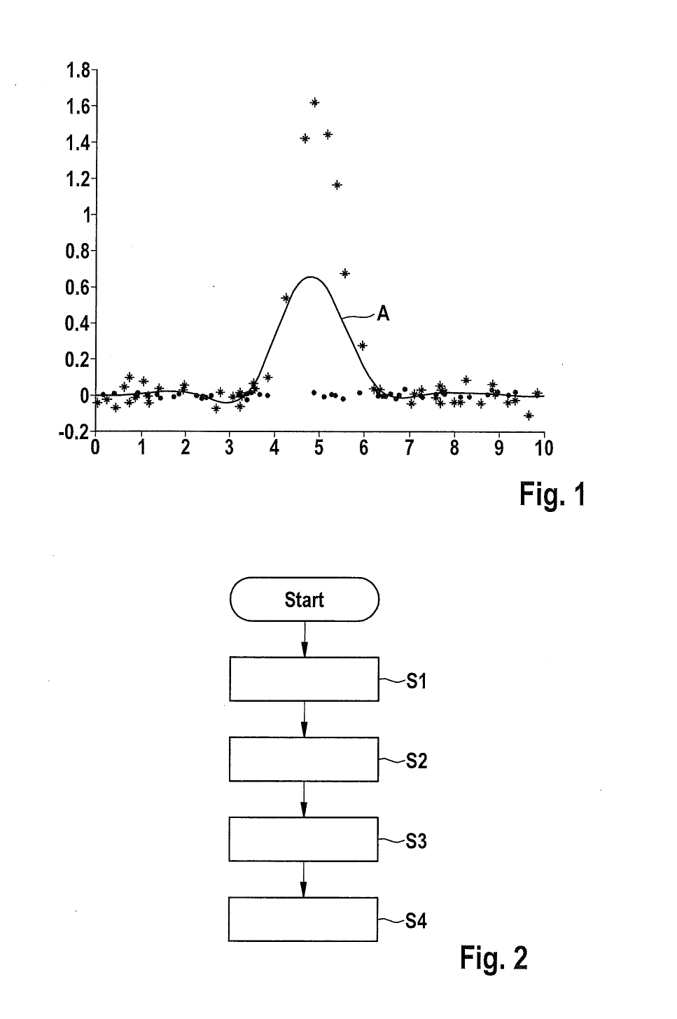

FIG. 1 shows a schematic illustration of a first and a second training data record, which are to be taken into consideration by way of example in a data-based function model. The following method is also usable without difficulty for more than two training data records. The first and second training data records include measuring points, each having an input variable (x axis) and a resulting output variable (y axis). The measuring points of the first training data record are identified by the symbol “” and the measuring points of the second training data record are identified by the symbol “*”. In the present case, each training data record has 50 measuring points, some of which contradict each other, in particular in the range between X=3.5 and 6.5.

Curve A indicates the progression of the function values of a data-based function model formed of the set union of the measuring points of the first and second training data records.

FIG. 2 shows a flow chart to illustrate the method for creating a data-based function model on the basis of the first and second training data records, taking a selected weighting of the second training data record with respect to the first training data record into consideration. The method starts in step S1 with the provision of a first training data record. A data-based function model has frequently already been created from a first training data record, which is provided as a Gaussian process model in the form of hyperparameters and node data, i.e., a portion of the measuring points or all measuring points of the first training data record.

In step S2, the measuring points of the second training data record are provided, which were detected by a remeasurement, for example, in particular after a change of the system to be measured or of the measuring sensors. The second training data may include the collectivity of the measuring points detected by the remeasurement, or only a portion of the same.

In step S3, a user now has the option to enter or select the weighting of the consideration of the measuring points of the first and second training data records in a function model to be created subsequently in the form of weighting specifications w₁, w₂. The function model to be created subsequently is to be created based on a training data volume which includes the measuring points of the first training data record and the measuring points of the second training data record.

Thereafter, in step S4, the new updated Gaussian process model is ascertained as follows based on the weighted measuring points of the first and second training data records:

v=f(u)=k(u, X) (K+σₙ²Ψ)⁻¹Y

where X represents a matrix of the measuring points of the input data of the training data record, Y represents a vector of the output data for the measuring points, K represents a covariance matrix of the measuring points X of the training data, and W represents a weighting matrix having N (total number of measuring points of the training data record union) entries. Moreover, k(u,X) corresponds to a covariance function with respect to the test point u having the training data in X.

The above Gaussian process model is determined by applying the marginal likelihood method. For example, the determination may take place by maximizing the covariance matrix K_{N} in

p(y/X, Θ)=N(y/0, K_{N}+σ²Ψ)

for hyperparameter Θ and training data X having number N. The usual term σ²I, in which I corresponds to the identity matrix and specifies equal weightings of all measuring points, was replaced here by term σ²Ψ having weighting matrix Ψ.

To introduce weightings of individual measuring points, weighting matrix Ψ is thus provided in term σ²Ψ, to which covariance matrix K_{N} is applied. Ψ corresponds to a diagonal matrix having different weightings for the different measuring points.

Weightings w₁, w₂ may generally be used differently. A possible determination of weighting matrix Ψ for two sets/data records is described hereafter by way of example. To weight the measuring points of the first training data record and of the second training data record, weighting specifications w₁, w₂ (w₁=weighting for the measuring points of the first training data record, w₂=weighting for the measuring points of the second training data record) are converted as follows into the entries of the weighting matrix:

$${ψ}_{2} = ( 1 - {w}_{2} ) \frac{{NN}_{2}}{( 1 - {w}_{2} ) {N}_{2}^{2} + ( 1 - {w}_{1} ) {N}_{1}^{2}}$$

$$or$$

$${ψ}_{1} = ( 1 - {w}_{1} ) \frac{{NN}_{1}}{( 1 - {w}_{2} ) {N}_{2}^{2} + ( 1 - {w}_{1} ) {N}_{1}^{2}}$$

where N=N₁+N₂
and N₁ corresponds to the number of measuring points of the first training data record and N₂ corresponds to the number of measuring points of the second training data record.

Factors Ψ₁ and Ψ₂ are thus calculated from the weightings and written to the diagonal of weighting matrix Ψ. For the values of diagonal matrix Ψ, it then applies that Ψ_{j,i=Ψ}₁ if the ith measuring point is part of the set of the first training data record, and Ψ_{i,i}=Ψ₂ if the ith measuring point is part of the set of the second training data record. Moreover, Ψ_{i,j}=0 applies for all i≠j.

The method is analogously also usable for more than two training data records. The selected weightings {w1, w2 . . . wz} E[0; 1] are selected in such a way that they add up to 1 in total.

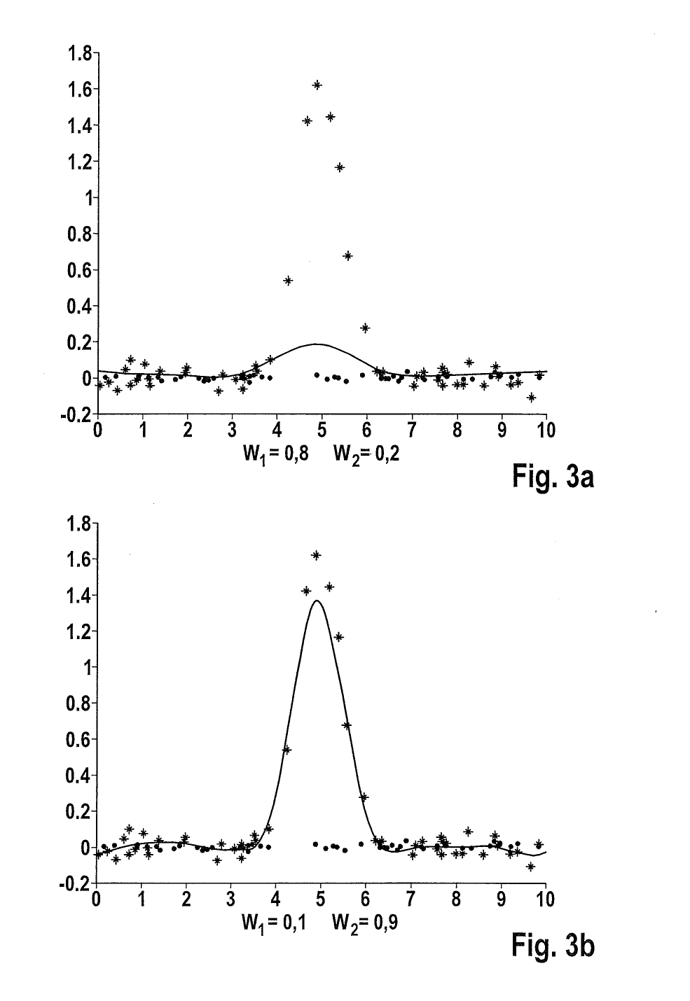

FIGS. 3a and 3b illustrate the function value curves of a weighted union of the measuring points of the first training data record and of the second training data record for different weightings. As above, the measuring points of the first training data record are identified by the symbol “” and the measuring points of the second training data record are identified by the symbol “*”. For weightings w₁=0.8 and w₂=0.2, FIG. 3a shows that the curve of the function values of the data-based function model is closer to the measuring points of the first training data record, while it is apparent from the weightings of w₁=0.1 and w₂=0.9 in FIG. 3b that the curve of the data-based function model thus created is closer to the measuring points of the second training data record.

The creation of the data-based function model may take place in an arithmetic unit having a user interface via which the user is able to carry out a suitable selection of the weightings for each training data record to be considered.

What is claimed is:

1. A method for creating a nonparametric, data-based function model having measuring points in multiple training data records, the method comprising:
providing weighting specifications for the measuring points of each training data record;
forming a set union of the measuring points of the multiple training data records; and
creating the nonparametric function model from the set union of the measuring points of the training data records according to an algorithm which is dependent on the weighting specifications for the measuring points of the multiple training data records.

2. The method of claim 1, wherein the multiple weighting specifications are selected or determined by a user.

3. The method of claim 1, wherein the nonparametric function model is defined with the aid of a covariance matrix, a diagonal matrix being applied to the covariance matrix, the diagonal matrix values which are assigned to the measuring points of the multiple training data records being dependent on the multiple weighting specifications.

4. The method of claim 1, wherein the measuring points of the training data records are in each case assigned a level of a variance which is determined by the weighting specification assigned to the training data record in question.

5. The method of claim 1, wherein the nonparametric, data-based function model is ascertained as a Gaussian process model or as a sparse Gaussian process model.

6. A device, for adapting a nonparametric, data-based function model having measuring points in multiple training data records, comprising:
an processor arrangement, having an arithmetic unit, configured to perform the following:
provide weighting specifications for the measuring points of each training data record;
form a set union of the measuring points of the multiple training data records; and
create the nonparametric, data-based function model from the set union of the measuring points of the training data records according to an algorithm which is dependent on the weighting specifications for the measuring points of the multiple training data records.

7. The device of claim 6, wherein the multiple weighting specifications are selected or determined by a user.

8. The device of claim 6, wherein the nonparametric function model is defined with the aid of a covariance matrix, a diagonal matrix being applied to the covariance matrix, the diagonal matrix values which are assigned to the measuring points of the multiple training data records being dependent on the multiple weighting specifications.

9. The device of claim 6, wherein the measuring points of the training data records are in each case assigned a level of a variance which is determined by the weighting specification assigned to the training data record in question.

10. The device of claim 6, wherein the nonparametric, data-based function model is ascertained as a Gaussian process model or as a sparse Gaussian process model.

11. A computer readable medium having a computer program, which is executable by a processor, comprising:
a program code arrangement having program code for creating a nonparametric, data-based function model having measuring points in multiple training data records, by performing the following:
providing weighting specifications for the measuring points of each training data record;
forming a set union of the measuring points of the multiple training data records; and
creating the nonparametric function model from the set union of the measuring points of the training data records according to an algorithm which is dependent on the weighting specifications for the measuring points of the multiple training data records.

12. The computer readable medium of claim 11, wherein the multiple weighting specifications are selected or determined by a user.

13. The computer readable medium of claim 11, wherein the nonparametric function model is defined with the aid of a covariance matrix, a diagonal matrix being applied to the covariance matrix, the diagonal matrix values which are assigned to the measuring points of the multiple training data records being dependent on the multiple weighting specifications.

14. The computer readable medium of claim 11, wherein the measuring points of the training data records are in each case assigned a level of a variance which is determined by the weighting specification assigned to the training data record in question.

15. The computer readable medium of claim 11, wherein the nonparametric, data-based function model is ascertained as a Gaussian process model or as a sparse Gaussian process model.

16. An electronic control unit, comprising:
an electronic memory medium having a computer program, which is executable by a processor, including:
a program code arrangement having program code for creating a nonparametric, data-based function model having measuring points in multiple training data records, by performing the following:
providing weighting specifications for the measuring points of each training data record;
forming a set union of the measuring points of the multiple training data records; and
creating the nonparametric function model from the set union of the measuring points of the training data records according to an algorithm which is dependent on the weighting specifications for the measuring points of the multiple training data records.

17. The electronic control unit of claim 16, wherein the multiple weighting specifications are selected or determined by a user.

18. The electronic control unit of claim 16, wherein the nonparametric function model is defined with the aid of a covariance matrix, a diagonal matrix being applied to the covariance matrix, the diagonal matrix values which are assigned to the measuring points of the multiple training data records being dependent on the multiple weighting specifications.

19. The electronic control unit of claim 16, wherein the measuring points of the training data records are in each case assigned a level of a variance which is determined by the weighting specification assigned to the training data record in question.

20. The electronic control unit of claim 16, wherein the nonparametric, data-based function model is ascertained as a Gaussian process model or as a sparse Gaussian process model.
